(19) United States
(12) Patent Application Publication
(10) Pub. No.: US 2006/0064652 A1
(43) Pub. Date: Mar. 23, 2006

(54) Input of punctuation marks

(75) Inventor: Jorma Michael Ahokas, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/946,567

(22) Filed: Sep. 20, 2004

(51) Int. Cl. G06F 3/00

(52) U.S. Cl. 715/864; 715/780; 715/773

(57) ABSTRACT

The invention relates in general to a method, a device and a computer program product for entering punctuation marks which appear in pairs within a text into a device. To enable fast and efficient entering of the pair of punctuation marks, the invention provides entering the punctuation marks through a restricted keyboard requiring a selection of punctuation marks through a special characters menu, showing the entered punctuation marks on a display of the device, wherein the punctuation marks are selected within the special characters menu by entering the special characters menu only once in such a way that both punctuation marks are shown in the display after selection.

### BACKGROUND OF THE INVENTION

The invention relates in general to a method for entering punctuation marks which appear in pairs within a text into a device.

The invention further relates in general to a device arranged for entering punctuation marks which appear in pairs in a text.

Further, the invention relates to a computer program product for entering punctuation marks which appear in pairs in a text into a device.

When entering text into devices difficulties can appear when entering punctuation marks. For example, punctuation marks can be ( ), [ ], { }, < >, ? [symbol] , “ ”, ‘ ’, ″ ″ and others. In particular, when entering these punctuation marks in pairs, restriction due to restricted keyboards can be annoying to users.

On full keyboards, where there is a modifier key such as SHIFT, CTRL, or ALT, for entering the punctuation marks, the characters can be input into the device without too much effort.

However, certain devices only provide restricted keyboards, which do not have a modifier key for entering the punctuation marks. Examples of these devices are personal digital assistants (PDA), mobile digital assistants (MDA), mobile communication devices, mobile phones, pagers and others. In case the devices do not allow direct access to the punctuation marks, separate entry of the marks requires a complex interaction between the user and the device. The cost, in terms of time, for entering the punctuation marks increases significantly.

For instance, in mobile phones, a special characters menu needs to be entered by pressing a particular key. After having entered the special characters menu, the required punctuation marks can be selected from a menu by using the keyboard to browse through all available punctuation marks within the special characters menu. After having browsed to the required punctuation mark, it can be selected by pressing a particular selection key on the keyboard. After having selected the punctuation mark, the special characters menu is automatically exited. In particular, when requiring punctuation marks which appear in pairs, the special characters menu needs to be entered again and the corresponding punctuation mark needs to be selected. Entering punctuation marks in pairs thus is annoying to users and consumes a lot of time.

### BRIEF SUMMARY OF THE INVENTION

To overcome these drawbacks, embodiments of the invention provide a method for entering punctuation marks which appear in pairs within a text into a device with entering the punctuation marks through a restricted keyboard requiring selection of the punctuation marks through a special characters menu, and showing the entered punctuation marks on a display of the device, wherein the punctuation marks are selected within the special characters menu by entering the special characters menu only once in such a way that both punctuation marks are shown in the display after selection.

The inventive method enables users to enter both characters in punctuation pairs simultaneously. Having entered the special characters menu, the user can enter both of the required special characters at once and the selected pair of punctuation marks is immediately displayed on the display. It is not required to enter the special characters menu more than once to input the pair of punctuation marks.

The time required for entering the pair of punctuation marks is halved. Users can easily use the pair of punctuation marks, which are shown on the display after exiting the special characters menu. Entering the special characters menu twice is not required anymore.

According to embodiments, the special characters menu provides the pair of punctuation marks within a selectable item. The selectable item can be a selectable button or selectable field, which represent the respective pair of punctuation marks. For instance, buttons representing ( ), [ ], { }, or “ ”, or any other pair of punctuation marks can be provided. The user can select one of these items and the pair of punctuation marks is immediately shown on the display.

According to embodiments, a continuous selection of punctuation marks within the special characters menu is provided, in such a way that at least two punctuation marks are selectable after entering the special characters menu and before exiting automatically the special characters menu. According to these embodiments, the user is enabled to enter the special characters menu and to select two punctuation marks after which an automated exit from the special characters menu is initiated. As the special characters menu provides access to all punctuation marks, a user can select the two punctuation marks, which are required for providing the pair of punctuation marks. After having selected two of the provided punctuation marks, the exit from the special characters menu can automatically be initiated.

The automatic exit from the special characters menu after the pair of punctuation marks is selected is provided according to another embodiment.

One further embodiment provides showing the pair of punctuation marks on the display and providing a text entry cursor in between punctuation marks for further text entry. For example, there may be an item such as ( ), which allows entering both brackets at once. After having selected this item, the brackets are displayed and text entry cursor is positioned in between the brackets. The user can enter the text immediately in between these brackets. After having entered the text which should be embraced by the punctuation marks, the user needs only to move the text entry cursor outside the punctuation marks by pressing an appropriate key on the keyboard.

One embodiment provides a virtual keyboard. This virtual keyboard may be shown in the display. A user can use the display for entering the text using the shown virtual keyboard. Even this virtual keyboard may require a special characters menu. Having entered the special characters menu, the virtual keyboard shows all available special characters and the user can select the characters on the virtual keyboard.

According to further embodiments, selecting text within the display, entering the special characters menu, selecting the pair of punctuation marks, and showing the selected text embraced by the selected punctuation marks after exiting the special characters menu is also provided. The pair of punctuation marks can thus be applied to a selected text. The user can select the text, which is intended to be placed in between the pair of punctuation marks. After having entered the special characters menu, the pair of punctuation marks can be selected by the user. The selected text is automatically embraced by the selected punctuation marks.

Other embodiments provide switching off the method of entering the punctuation marks which appear in pairs within a text by entering the special characters menu only once. In that case, a user can select whether it should be possible to enter the pair of punctuation marks during entering the special characters menu once or not. For instance, suppose a user wants to enter “smileys”, which can be combination of punctuation marks such as: ;-) / :-) / (c; / :C) /=0) and others. To enable entering these smileys, it has to be possible to switch off the functionality of simultaneously selecting a pair of punctuation marks in a special characters menu, for instance of a mobile device.

A further aspect of the invention is a device arranged for entering punctuation marks which appear in pairs within a text comprising a display for displaying the entered punctuation marks, a restricted keyboard arranged for entering the punctuation marks through a special characters menu, and a menu processor displaying a special characters menu on the display for selecting the punctuation marks using the keyboard, wherein the menu processor is arranged for displaying the punctuation marks within the special characters menu and for selecting both punctuation marks while entering the special characters menu only once in such a way that both punctuation marks are shown in the display after selection.

The restricted keyboard allows entering usual characters only. Punctuation marks can not be entered directly through the restricted keyboard. For entering the punctuation marks, the menu processor provides a special characters menu which can be shown on the display. Within the special characters menu, the menu processor enables selecting punctuation marks using the keyboard. The menu processor further enables displaying the punctuation marks within the special characters menu. In addition, the menu processor enables a user selection of pairs of punctuation marks when the special characters menu is entered. The menu processor is arranged in such a way that the pair of punctuation marks can be selected during entering the special characters menu only once. The selected pair of punctuation marks is shown on the display after selection.

According to embodiments, the menu processor is arranged for providing the pairs of punctuation marks within one selectable item. This one selectable item can be a button or a field, which is selectable by using the restricted keyboard. This button or field may display the pair of punctuation marks and the user can directly select this pair of punctuation marks within the special characters menu.

Further embodiments provide a menu processor, which is arranged for providing continuous selection of punctuation marks within a special characters menu in such a way that at least two punctuation marks are selectable after entering the special characters menu.

This arrangement enables entering a pair of punctuation marks by selecting at least two single special characters. The processor can be arranged in such a way that the user can select at least two of the punctuation marks. By selecting two of the punctuation marks, the user can select the required pair of punctuation marks.

Embodiments provide exiting the special characters menu automatically after the pair of punctuation marks is selected. The menu processor may also be programmed in such a way that it initiates an exit from the special characters menu after two punctuation marks have been selected.

Further embodiments provide displaying the keyboard on the display and providing text entry through the displayed keyboard. The text entry through the displayed keyboard may be facilitated by browsing the displayed keyboard using navigation keys. It may also be possible to provide touch sensitive text input. In that case, the display can be a touch sensitive display enabling touch entry of the text.

Further embodiments provide at least a keyboard, a display and a menu processor in a mobile communication device. This may be a mobile phone.

Another aspect of the invention is a computer program product for entering punctuation marks which appear in pairs within a text into a device, wherein the product comprises instructions operable to cause a processor within the device to receive entered punctuation marks from a restricted keyboard, provide a special characters menu for a selection of the punctuation marks, show the entered punctuation marks on a display, provide selection of the punctuation marks within the special characters menu by entering the special characters menu only once, and show both punctuation marks in the display after selection.

### BRIEF DESCRIPTION OF THE DRAWINGS

The drawings show:

FIG. 1: A mobile phone having a menu processor;

FIG. 2: a flow chart of an inventive method;

FIG. 3: a screenshot of a special characters menu;

FIG. 4: a screenshot of a text input view;

FIG. 5: a further screenshot of a text input view;

FIG. 6: another screenshot of a text input view;

FIG. 7: a further screenshot of a text input view with a highlighted text; and

FIG. 8: another screenshot of a text input view.

### DETAILED DESCRIPTION OF THE INVENTION

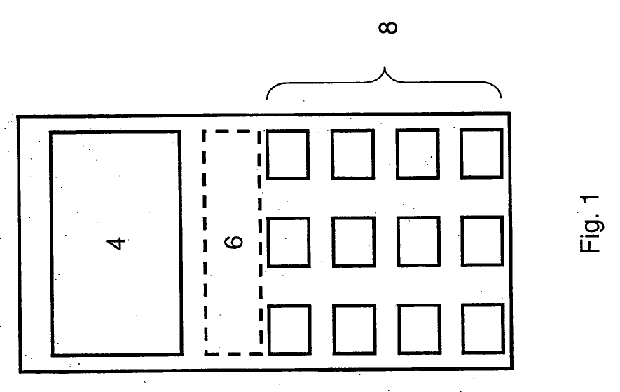

FIG. 1 shows a mobile communication device 2. This may be a mobile phone, a personal digital assistant or any other device capable of mobile communication. The mobile communication device 2 comprises a display 4, a menu processor 6 and a restricted keyboard 8.

The mobile communication device 2 can be programmed using a computer program product which enables operating the mobile communication device 2 with the claimed method.

Keyboard 8 is a restricted keyboard, which only enables inputting common alphabetic characters. Keyboard 8 also enables browsing within a menu using navigation keys and entering a special characters menu using the navigation keys. Special characters may not be directly inputted using keyboard 8, however, they may be inputted through the special characters menu.

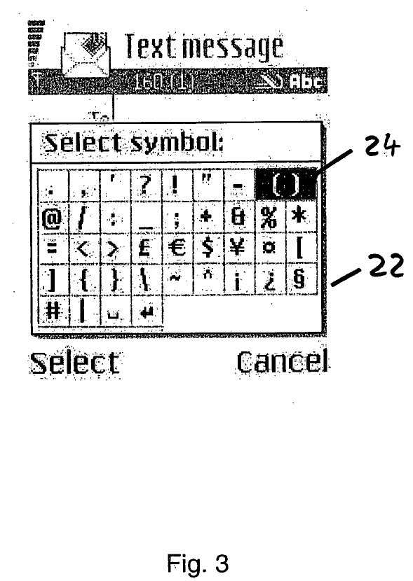

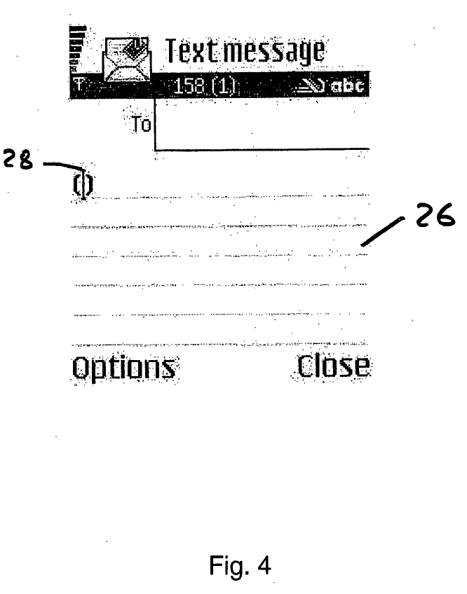

Menu processor 6 enables the providing of menus and displaying these within the display 4. These menus can be, for instance, text input menus, which enable inputting text, as will be shown in FIGS. 4-7 and 8. Further, menu processor 6 can provide a special characters menu, which will be displayed on display 4 and is shown within FIG. 3. The mobile communication device 2 as depicted in FIG. 1 enables entering plain text as well as special characters. The text may, for instance, be sent to another user via a mobile communication network using a message protocol such as a short message service (SMS) or a multimedia message service (MMS) or any other text-based communication protocol.

After having selected a particular navigation key with the function of entering the special characters menu on keyboard 8, this special characters menu is generated by menu processor 6 and displayed on display 4. The user can browse through the special characters menu on display 4 using particular navigation keys on keyboard 8. Browsing the special characters menu enables browsing to an item which provides a pair of punctuation marks. This item can be selected using a key on keyboard 8, after which selection the menu processor 6 initiates an automatic exit from the special characters menu and displays on display 4 the text input view. This text input view shows the selected pair of punctuation marks.

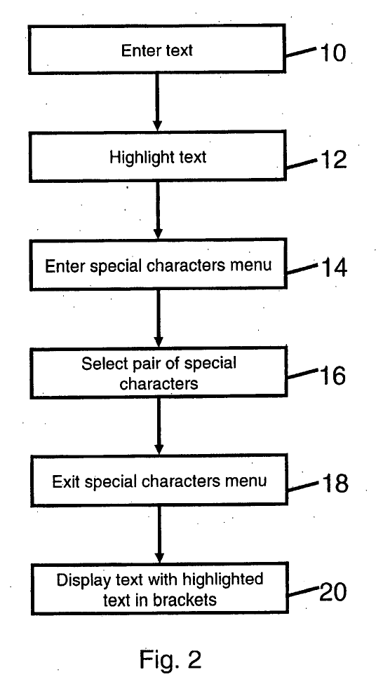

FIG. 2 shows an example flowchart of a method according to the invention. For entering text, the user can enter a text input menu (10). In case the user wants to place inputted text in between, for instance, brackets, the user can highlight the particular text (12). After having highlighted the particular text (12), the user can enter a special characters menu (14). Within the special characters menu, the user can browse to an item, which represents a pair of punctuation mark (16). This item can be a pair of brackets ( ). The user can select this pair of brackets ( ). After selection the special characters menu is exited automatically (18). After exiting the special characters menu 18 the display shows the inputted text (20). As the pair of brackets ( ) has been selected within the special characters menu, the display shows the highlighted text embraced by these brackets ( ).

FIG. 3 shows a screenshot of a special characters menu 22. The special characters menu 22 comprises an area of various special characters. Within this area of special characters, one item 24 represents a pair of brackets ( ). The user can browse through the area of various special characters and direct the cursor to the pair of brackets ( ). This can be indicated by highlighting the pair of brackets ( ). The user can select this item 24 by pressing a selection key on the keyboard. After having selected the pair of brackets ( ), a text or message view as shown in FIG. 4 is displayed.

Within FIG. 4, a screenshot of a text input view 26 is shown. Within this text input view 26, text can be inputted and displayed. Shown in FIG. 4 is the pair of brackets ( ) within the text input view 26. As can be seen, a text input cursor 28 is placed in between the brackets ( ), to enable a user to enter any text directly in between the brackets ( ).

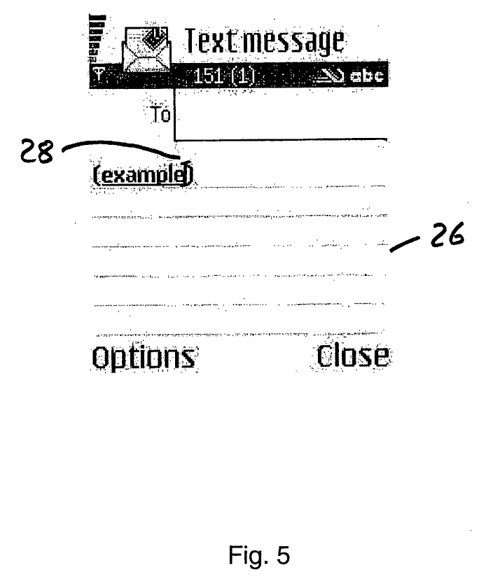

A screenshot of a possible user input is shown in FIG. 5. Within the text input view 26, the user has inputted the text “example” within the brackets ( ). For further text entry the user can move the cursor 28 outside the brackets ( ).

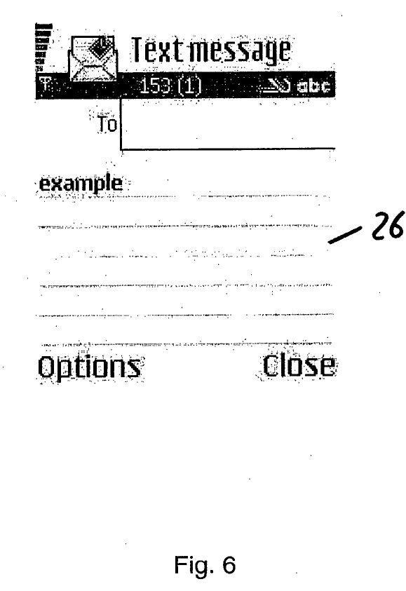

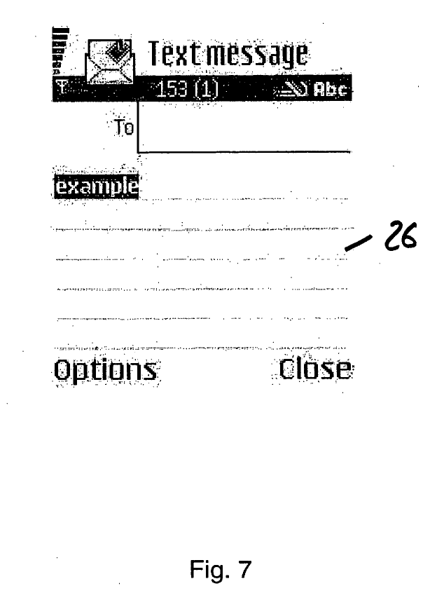

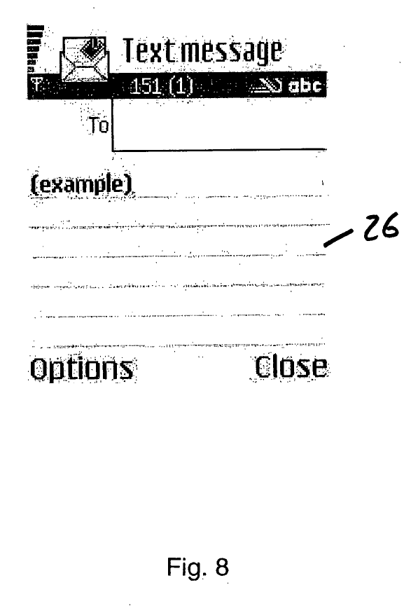

FIG. 6 shows a screenshot of a text input view 26, which already comprises inputted text “example”. To enable embracing this text “example” by brackets, the user can highlight this text as shown in FIG. 7. After having highlighted this text, the user can enter a special characters menu, as shown in FIG. 3 and select the item 24. After the selection of item 24, the text as shown in FIG. 8 is displayed on text input view 26. As the user has selected from the special characters menu a pair of brackets ( ), the text “example”, which has been previously highlighted, as was shown in FIG. 7, is now embraced by the brackets ( ).

The text input is made easier by the claimed method. In particular inputting pairs of punctuation marks can only require half the number keystrokes as with prior art systems. The efficiency and ease of use of the claimed method, device and computer program is significant, and users can input text faster.

I claim:

1. Method for entering punctuation marks which appear in pairs within a text into a device comprising
entering the punctuation marks through a restricted keyboard requiring selection of the punctuation marks through a special characters menu, and
showing the entered punctuation marks on a display of the device, wherein
the punctuation marks are selected within the special characters menu by entering the special characters menu only once in such a way that both punctuation marks are shown in the display after selection.

2. Method of claim 1, comprising providing pairs of punctuation marks within the special characters menu within one selectable item.

3. Method of claim 1, comprising providing continuous selection of punctuation marks within the special characters menu in such a way that at least two punctuation marks are selectable after entering the special characters menu.

4. Method of claim 1, comprising exiting the special characters menu automatically after the pair of punctuation marks has been selected.

5. Method of claim 1, comprising showing the pair of punctuation marks on the display and providing a text entry cursor in between the punctuation marks for further text entry.

6. Method of claim 1, comprising showing the keyboard on the display and providing text entry through the shown keyboard.

7. Method of claim 1, comprising selecting text within the display, entering the special characters menu, selecting the pair of punctuation marks, and showing the selected text embraced by the selected punctuation marks after exiting the special characters menu.

8. Method of claim 1, comprising providing switching off the method of entering the punctuation marks which appear in pairs within a text by entering the special characters menu only once.

9. Device arranged for entering punctuation marks which appear in pairs within a text comprising
a display for displaying the entered punctuation marks,
a restricted keyboard arranged for entering the punctuation marks through a special characters menu, and
a menu processor displaying a special characters menu on the display for selecting the punctuation marks using the keyboard, wherein
the menu processor is arranged for displaying the punctuation marks within the special characters menu and allows selecting a pair of punctuation marks while entering the special characters menu only once in such a way that the pair of punctuation marks are shown in the display after selection.

10. Device of claim 9, wherein the menu processor is arranged for providing at least one pair of punctuation marks within the special characters menu within a selectable item.

11. Device of claim 9, wherein the menu processor is arranged for providing continuous selection of punctuation marks within the special characters menu in such a way that at least two punctuation marks are selectable after entering the special characters menu.

12. Device of claim 9, wherein the menu processor is arranged for exiting the special characters menu automatically after the pair of punctuation marks has been selected.

13. Device of claim 9, wherein the display is arranged for showing the keyboard and providing text entry through the shown keyboard.

14. Device of claim 9, wherein a keyboard, a display and a menu processor are arranged within a mobile communication device.

15. Computer program product for entering punctuation marks which appear in pairs within a text into a device, wherein the product comprises instructions operable to cause a processor within the device to
receive entered punctuation marks from a restricted keyboard,
provide a special characters menu for selection of the punctuation marks,
show the entered punctuation marks on a display, provide selection of a pair of punctuation marks within the special characters menu by entering the special characters menu only once, and
show the pair of punctuation marks in the display after selection.
